(19) United States
(12) Patent Application Publication
(10) Pub. No.: US 2020/0391924 A1
(43) Pub. Date: Dec. 17, 2020

(54) PAPER-BASED KITCHEN & TABLEWARE MOVING OR PACKING KITS

(71) Applicants: Steve Kohn, Short Hills, NJ (US); Amy Rigazio, Farmingdale, NY (US)

(72) Inventors: Steve Kohn, Short Hills, NJ (US); Amy Rigazio, Farmingdale, NY (US)

(21) Appl. No.: 16/438,273

(22) Filed: Jun. 11, 2019

(51) Int. Cl. B65D 81/02; B32B 3/28; B65D 5/49

(52) U.S. Cl. CPC B65D 81/025; B65D 5/48026; B32B 3/28

(57) ABSTRACT

A moving kit for tableware and kitchen items utilizing all paper-based components. The kit is comprised of paper wrappers for surface protection and single face corrugate for cushioning. Separating these two features of traditional foam products into distinct components creates a more flexible user experience and the paper-based materials reduces the waste of single use plastic.

### FIELD OF THE INVENTION

The present invention relates to paper-based kitchen and tableware moving or packing kits.

### BACKGROUND OF THE INVENTION

Current moving or packing kits offered for people to pack their dishes, bowls, mugs, and glasses are comprised of poly-based foams that are often used in conjunction with cardboard dividers and a box or container. The foam can be supplied as pockets into which individual items are placed, or as sheets which are used to wrap individual items. If used, the dividers segment a moving box or container into small compartments. Once covered by the foam, items are placed into the small compartments. If dividers are not used, the foam wrapped items are placed directly into the moving box or container.

With people looking to reduce plastic waste and choose more sustainable options, the present invention provides fully paper-based kitchen moving or packing kits. individual paper wrappers provide the surface protection of foam while single face corrugate sheets provide the cushioning of foam. By separating these two features in the same kit, a person can choose the type of protection be or she needs. This more flexible kit allows the user to determine where and how to best use the provided materials for his or her application.

U.S. Pat. No. 6,138,832 relates to a kit for packing residential or business goods for containers in its constructive position, wrapping materials for safely securing and placing items within the container, markers and other means for indelibly marking items and instructions for use of the kit.

U.S. Pat. No. 4,915,247 relates to packing for packaged goods stacked or provided with straight edges having a plurality of packing pieces made of packing material bent or folded in the vicinity of the edges of the packaged goods. The packing pieces have packing bars with an angular transverse cross section which are juxtaposed with and receive the edges of the packaged goods. The packing bars are assembled into a supporting framework with at least one open frame area in contrast to solid panels.

US patent publication 20160152361 relates to an assembling apparatus for wrapping one or more silverwares into a napkin.

### SUMMARY OF THE INVENTION

The present invention comprises paper wrappers to individually wrap items and single face corrugate to protect items as part of a moving or packing kit. Single face corrugate is a material comprised of a paper sheet formed into arches or flutes that is laminated to a single layer of flat linerboard. The size of the fluting can vary depending on the amount of protection and cushioning that is needed. It is an object of the present invention for the moving or packing kit to provide surface protection and cushioning for items such as plates, howls, glasses or other tableware. It is an object of the present invention for the moving or packing kit to contain multiple sizes of paper wrappers to wrap items of different dimensions. It is an object of the present invention for the moving or packing kit to contain multiple quantities of paper wrappers of the same size, it is an object of the present invention for the paper wrappers to range in size from about 4 inches to 24 inches in width and about 4 inches to 24 inches in length. it is an object of the present invention for the moving or packing kit to contain single face corrugate that is flexible in one direction and rigid in the opposite direction. It is an object of the present invention for the single face corrugate to range from A flute to F flute, it is an object of the present invention for the moving or packing kit to contain single face corrugate rolls. It is an object of the present invention for the single face corrugate rolls to range in width from about 4 inches to 24 inches and in length from about 24 inches to 50 feet. It is an object of the present invention for the moving or packing kit to contain single face corrugate pre-cut sheets. it is an object of the present invention for the single face corrugate pre-cut sheets to range in width from about 4 inches to 24 inches and in length from about 4 inches to 24 inches.

It is an object of the present invention for each paper wrapper to be closed on two adjacent sides, creating a pouch inside which an item can be easily placed. It is an object of the present invention for each paper wrapper to be closed on two opposite sides, creating a sleeve inside which an item can be easily placed. It is an object of the present invention for each wrapper to be dosed on three sides, creating a pouch inside which an item can be easily placed. It is an object of the present invention for the closures to be created by gluing, sewing, sealing, or folding.

It is an object of the present invention that the flexible nature of the paper allows for the wrapper to mold around the contour of an item to prevent the wrapper from fatting off the item. It is the object of the present invention for the wrapper to be molded around the contour of an item to provide surface protection for the item. It is an object of the present invention for multiple wrappers to be used for each item to provide additional surface protection.

It is an object of the present invention for the paper wrapper to be printed with information such as a corporate logo or advertising. It is an object of the present invention for the paper wrapper to be printed with a coupon. It is an object of the present invention for the coupon to be a peel off coupon. It is an object of the present invention for the paper wrapper to be unprinted.

It is an object of the present invention for the paper wrappers to be produced from 100% recycled content. It is an object of the present invention for the paper wrappers to be produced from a blend of recycled content and virgin content. It is an object of the present invention for the paper wrappers to be produced from 100% virgin content.

It is an object of the present invention for the paper wrappers to be produced from white paper. It is an object of the present invention for the paper wrappers to be produced from kraft or brown paper. It is an object of the present invention for the paper wrappers to be produced from white and kraft paper. It is an object of the present invention for the paper wrappers to be produced from colored paper.

It is an object of the present invention for single face corrugate sheets to provide additional cushioning for each item. It is an object of the present invention that the corrugate sheeting be rolled around individual items such as glasses. It is an object of the present invention for the corrugate sheeting to be placed between items such as plates to provide an extra layer of cushioning, It is an object of the present invention that the corrugate sheet be contoured and inserted into compartments created by cardboard dividers to fill voids between the object placed in the cardboard divider and the cardboard dividers. It is an object of the present invention that sheets be laid at the bottom of the moving box to create an extra layer of edge protection before packing. It is an object of the present invention that sheets be laid at the top of the open filled moving box to create an extra layer of edge protection before closing the box.

It is an object of the present invention for the single face corrugate sheet to be printed with information such as a corporate logo or advertising. It is an object of the present invention for the single face corrugate sheet to be printed with a coupon. It is an object of the present invention for the coupon to be a peel-off coupon. It is an object of the present invention for the single face corrugate sheet to be unprinted.

It is an object of the present invention for the single face corrugate sheets to be produced from 100% recycled content. It is an object of the present invention for the single face corrugate sheets to be produced from a blend of recycled content and virgin content. It is an object of the present invention for the single face corrugate sheets to be produced from 100% virgin content.

It is an object of the present invention for the single face corrugate sheets to be produced. from white paper. It is an object of the present invention for the single face corrugate sheets to be produced from kraft or brown paper. It is an object of the present invention for the single face corrugate sheets to be produced from white and brown paper. It is an object of the present invention for the single face corrugate sheets to be produced from colored paper.

### BRIEF DESCRIPTION OF THE DRAWINGS

FIGS. 1a, 1b and 1c show the paper wrappers in a variety of sizes.

FIG. 2a shows the single face corrugate sheeting laid flat. FIGS. 2b and 2c show the single face corrugate sheeting curved along the flexible material. direction.

FIGS. 3a, 3b and 3c show different sizes of objects being placed inside the paper wrappers.

FIGS. 4a, 4b and 4c show the paper wrappers contoured around the shapes of the various objects.

FIG. 5a shows the single face corrugate providing cushioning for a flat object. FIG. 5b shows the single face corrugate being rolled around a curved object.

FIG. 6 shows a moving box containing dividers in which items have been packed. The illustrated box is shown transparent for clarity.

FIG. 7 shows single face corrugate sheets installed at the bottom of a box before packing. The illustrated box is shown transparent for clarity.

FIG. 8 shows a moving box containing dividers in which items have been placed and single face corrugate sheets installed at the bottom of the box into which items are packed. The illustrated box is shown transparent for clarity.

FIG. 9 shows single face corrugate sheets installed at the top of a box into which items have being packed, The illustrated box is shown transparent for clarity.

FIG. 10 shows single face corrugate sheets installed at the top of a box before the box is closed.

### DETAILED DESCRIPTION OF THE DRAWINGS

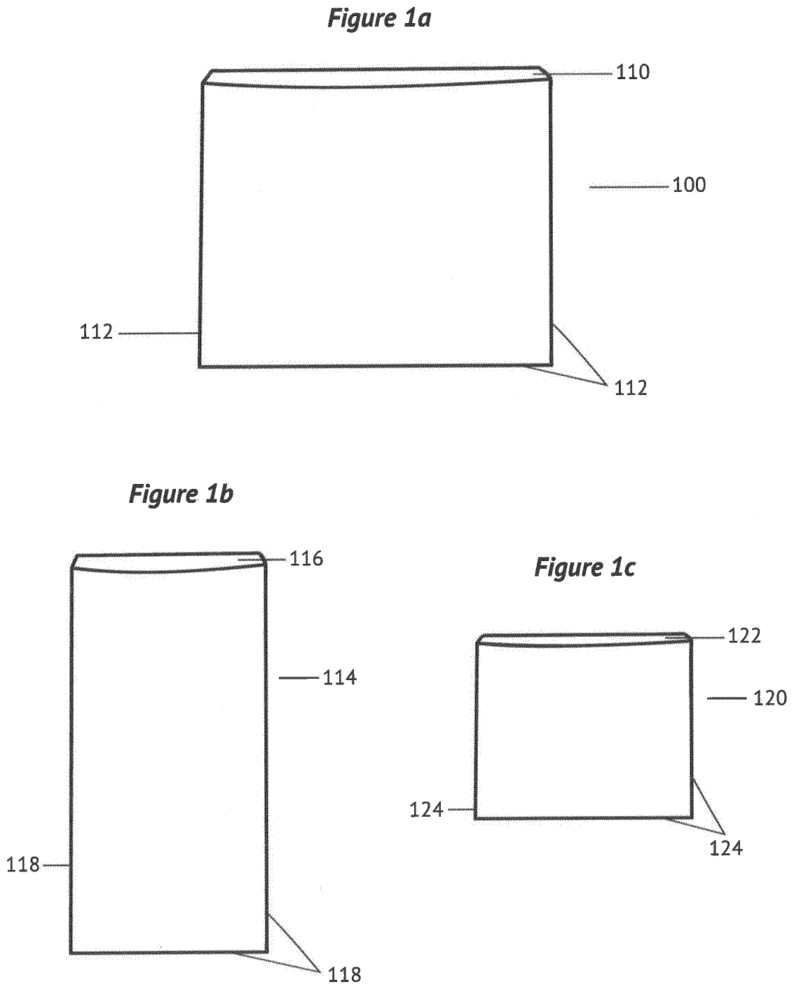

FIGS. 1a, 1b and 1c show the paper wrappers in several sizes and geometries. FIG. 1a shows a paper wrapper 100 for large objects such as dinner plates configured with one opening 110 and three closed sides 112. FIG. 1 b shows a paper wrapper 114 for long objects such as drinking glasses with one opening 116 and three closed sides 118. FIG. 1c shows a paper wrapper 120 for smaller objects such as bowls and mugs with one opening 122 and three closed sides 124. The sizes, shapes, and configurations shown in FIGS. 1a, 1b and 1c represent a sampling of sizes and shapes and do not represent the complete scope of possible configurations.

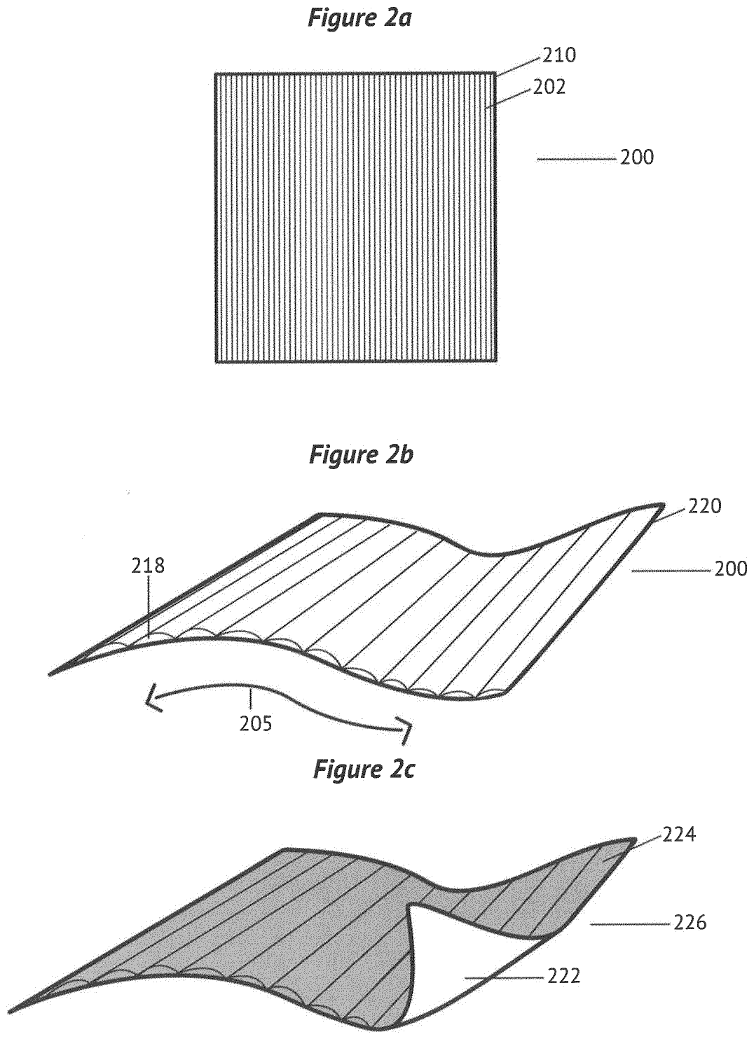

FIGS. 2a, 2b and 2c show single face corrugate sheets. The vertical lines 202 illustrated in sheet 200 denote the direction of the corrugation. FIG. 2a shows the sheet 200 as a fiat sheet 210 (fluting not shown), while FIG. 2b shows the sheet 200 having fluting 218 in a bent position 220 where the sheet bends and flexes horizontally across the corrugations as shown by arrow 205. FIG. 2c shows the single face corrugate sheet 226 comprising white paper 222 and kraft paper 224.

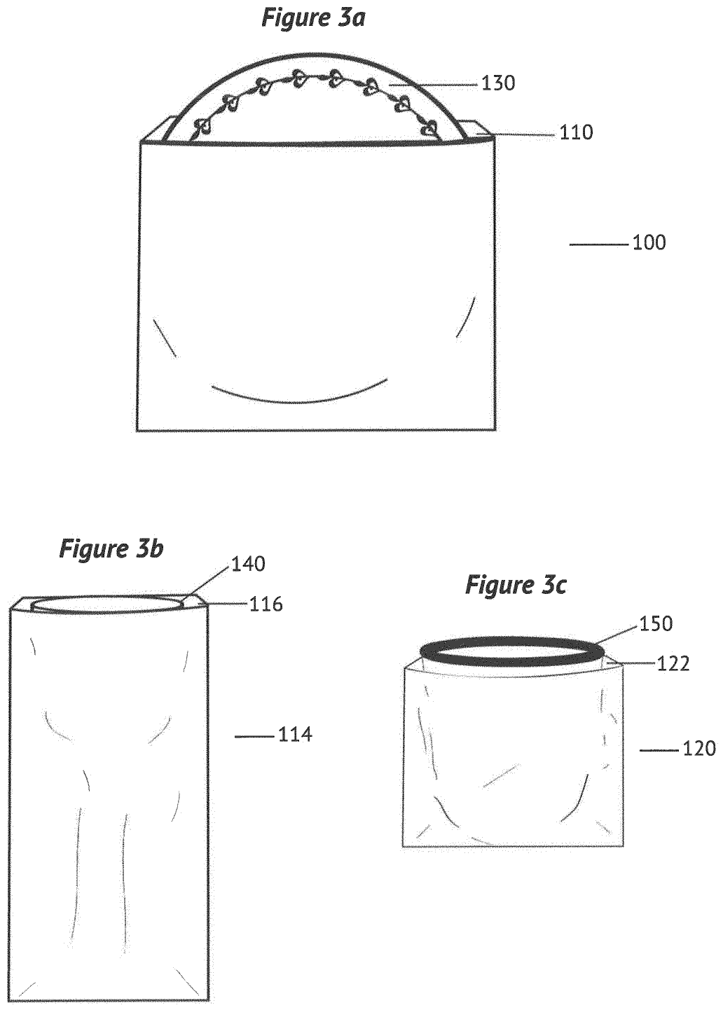

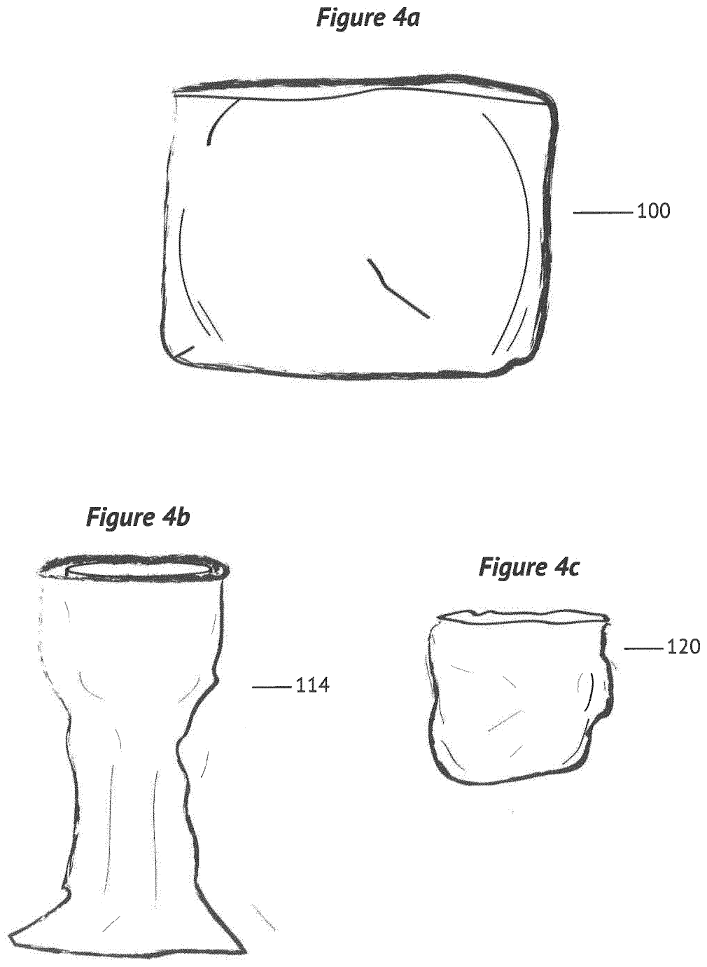

FIGS. 3a, 3b and 3c show objects being placed into three different paper wrappers. In FIG. 3a, a plate 130 is being inserted into the top opening 110 of a large wrapper 100. The plate 130 in FIG. 3a is not yet fully seated within the wrapper 100. In FIG. 3b, a drinking glass 140 is shown placed through the opening 116 of a long rectangular wrapper 114. In FIG. 3c, a mug 150 is shown being placed inside a smaller wrapper 120 through the opening 122. p FIGS. 4a, 4b and 4c show the paper wrappers 100, 114 and 120 molded around each of the objects described in FIGS. 3a, 3b and 3c. The paper wrappers 100, 114 and 120 are manipulated to match the shapes of each object, providing covering for all exposed surfaces.

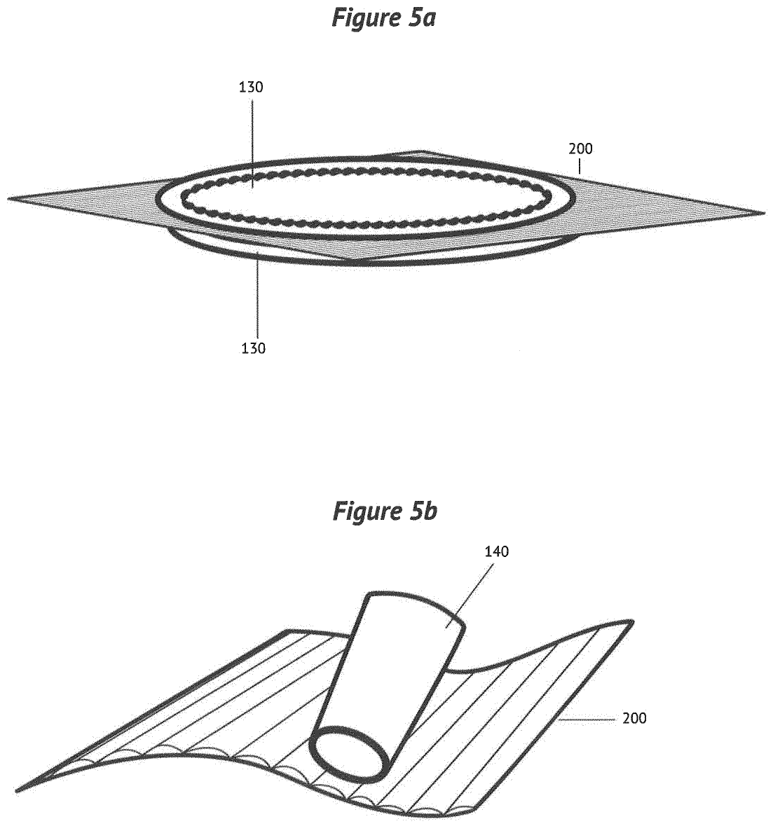

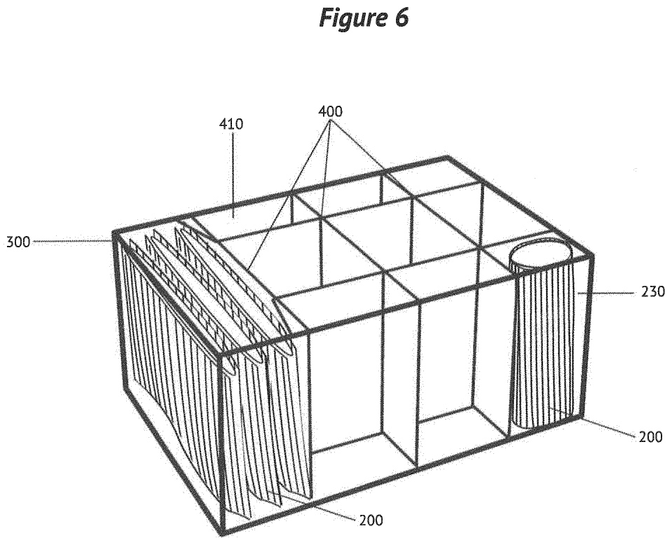

FIGS. 5a and 5B show two examples of the single face corrugate 200 providing cushioning. A flat corrugate sheet 200 is placed between two plates 130 in FIG. 5a, and a sheet of corrugate 200 is rolled around a drinking glass 140 in FIG. 5b.

FIG. 6 illustrates the moving or packing kit being used in conjunction with box dividers. The cardboard dividers 400 are inserted into a moving box 300 to create small individual. compartments 410. Objects that have been placed into paper wrappers are placed into the compartments 410. Single face corrugate sheets 200 are then contoured and inserted into the compartments 410 around the objects to fill voids 230. Larger items are packed into the compartments 410 with single face corrugate sheeting 200 placed between each object to provide cushioning,

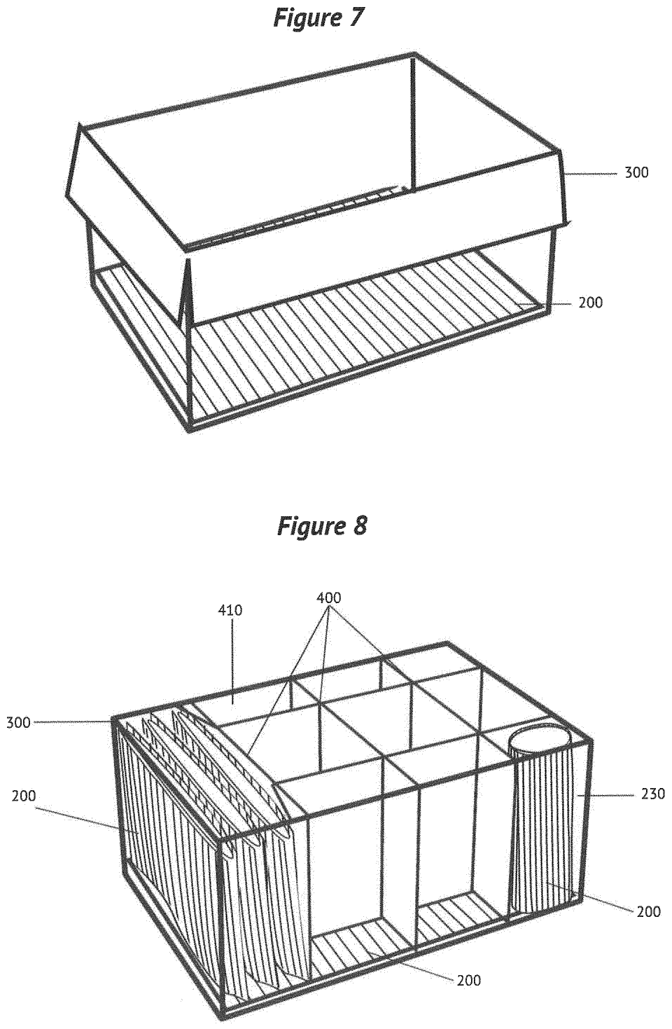

FIG. 7 shows single face corrugate sheets 200 placed on the bottom of a box 300 before objects are placed inside. This installation provides additional edge protection to objects that come in contact with the bottom of the box 300.

FIG. 8 shows a box 300 being packed after a layer of corrugate sheeting 200 has been placed at the bottom. of the box 300 for edge protection. Cardboard dividers 400 are installed into the box 300 and then wrapped objects are placed in the compartments 410. Single face corrugate sheets 200 are inserted around objects to fill voids 230 and placed between objects for additional cushioning.

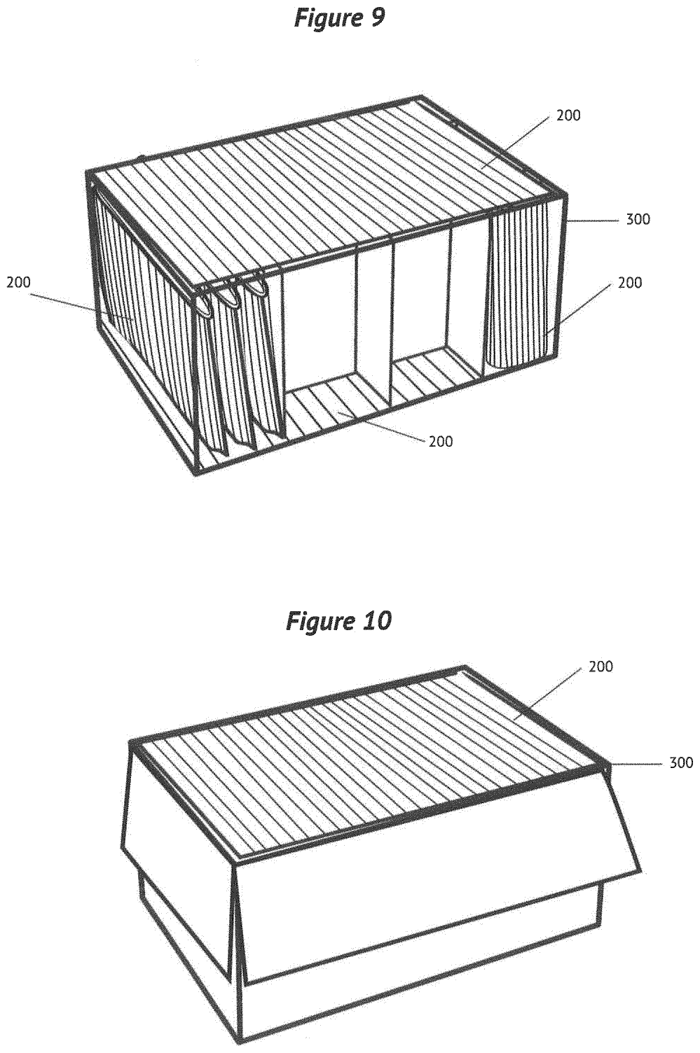

FIG. 9 shows single face corrugate sheets 200 placed on the top of a box 300, bottom of box 300, inserted around objects and between objects after objects are placed inside. This installation provides additional edge protection to objects that come into contact with the top of the box 300. FIG. 10 shows the packed box 300 after the top layer of corrugate sheeting 200 has been placed, and before the box 300 has been closed.

1. A moving kit or packing kit designed to protect and pack tableware items comprising:
paper wrappers closed on at least two sides to form a pouch;
single face corrugate in precut sheets;
said single face corrugate being a material comprised of a paper sheet formed into arches or flutes that are laminated to a single layer of fiat linerboard;
said single face corrugate is flexible in one direction and rigid in opposite direction.

2. The moving or packing kit of claim 1 wherein said kit further comprises dividers that separate a moving box into small compartments.

3. The moving or packing kit of claim 1 wherein said paper wrappers are provided in multiple sizes.

4. The moving or packing kit of claim 1 wherein said paper wrappers are provided in multiple quantities of the same size.

5. The moving or packing kit of claim 1 wherein said paper wrappers are printed with a logo or advertising.

6. The moving or packing kit of claim 1 wherein said paper wrappers are printed with a coupon.

7. The moving or packing kit of claim 6 wherein said coupon is a pea-off coupon.

8. The moving or packing kit of claim 1 wherein said paper wrappers provide surface protection by molding around contour of each object.

9. The moving or packing kit of claim 1 wherein said paper wrappers are used singly or in multiples to add additional surface protection to each object.

10. The moving or packing kit of claim 1 wherein said paper wrappers are produced from 100% recycled content.

11. The moving or packing kit of claim 1 wherein said paper wrappers are produced from paper containing recycled content.

12. The moving or packing kit of claim 1 wherein said paper wrappers are produced from 100% virgin content.

13. The moving or packing kit of claim 1 wherein said paper wrappers are produced from paper containing a blend of recycled content and virgin content.

14. The moving or packing kit of claim 1 wherein said paper wrappers are produced from either white or kraft paper.

15. The moving or packing kit of claim 1 wherein said paper wrappers are produced from white and kraft paper.

16. The moving or packing kit of claim 1 wherein said paper wrappers are produced from colored paper,

17. The moving or packing kit of claim 1 wherein said paper wrappers range in size from about 4 inches to 24 inches in width and about 4 inches to 24 inches in length.

18. The moving or packing kit of claim 1 wherein said paper wrapper is closed on three sides.

19. The moving or packing kit of claim 1 wherein said paper wrapper is closed on two adjacent sides.

20. The moving or packing kit of claim 1 wherein said paper wrapper is closed on two opposite sides.

21. The moving or packing kit of claim 1 wherein said paper wrapper is closed by being glued, sewn, sealed or folded.

22. The moving or packing kit of claim 1 wherein said single face corrugate is provided on a roll.

23. The moving or packing kit of claim 1 wherein said single face corrugate is printed with a logo or advertising.

24. The moving or packing kit of claim 1 wherein said single face corrugate is printed with a coupon.

25. The moving or packing kit of claim 24 wherein said coupon is a peel off coupon.

26. The moving or packing kit of claim 1 wherein said single face corrugate provides cushioning when placed between objects.

27. The moving or packing kit of claim 1 wherein said single face corrugate being moldable to contour around an object to provide cushioning and surface protection.

28. The moving or packing kit of claim 1 wherein said single face corrugate is placed in bottom of a box before objects are loaded.

29. The moving or packing kit of claim 1 wherein said single face corrugate is placed on top of a box after objects are loaded.

30. The moving or packing kit of claim 2 wherein said single face corrugate is rolled and inserted between said objects and said dividers.

31. The moving or packing kit of claim 1 wherein said single face corrugate is produced from 100% recycled content.

32. The moving or packing kit of claim 1 wherein said single face corrugate is produced from paper containing recycled content.

33. The moving or packing kit of claim 1 wherein said single face corrugate is produced from 100% virgin content.

34. The moving or packing kit of claim 1 wherein said single face corrugate is produced from paper containing a blend of recycled content and virgin content,

35. The moving or packing kit of claim 1 wherein said single face corrugate is produced from either white or kraft paper.

36. The moving or packing kit of claim 1 wherein said single face corrugate is produced from white paper and kraft paper.

37. The moving or packing kit of claim 1 wherein said single face corrugate is produced from colored paper.

38. The moving or packing kit of claim 1 wherein said single face corrugate is in a range of from A flute to F flute.

39. The moving or packing kit of claim 22 wherein width is in a range from about 4 inches to 24 inches and length is in a range from about 24 inches to 50 feet.

40. The moving or packing kit of claim 1 wherein said single face corrugate pre-cut sheets range in width from about 4 inches to 24 inches and in length from about 4 inches to 24 inches.

41. The moving or packing kit of claim 1 wherein said corrugate sheeting is rolled around individual items or placed between individual items.

42. A moving or packing kit comprising:
a container used in conjunction with cardboard dividers;
said dividers being inserted into said container to create small individual compartments;
objects placed into said compartments that are wrapped in paper wrappers;
single face corrugate sheets are placed in said container.

43. The moving or packing kit of claim 42 wherein larger objects are packed into said compartments with single face corrugate sheeting placed between each object to provide cushioning.

44. The moving or packing kit of claim 42 further comprising single face corrugate sheets placed on bottom of said container before objects are placed inside.

45. The moving or packing kit of claim 42 wherein said single face corrugate sheet is contoured and inserted into said compartments around said objects to fill voids in said compartment where said objects are placed.

46. The moving or packing kit of claim 42 wherein a single face corrugate sheet is placed on top of said container after objects are placed inside.

47. The moving or packing kit of claim 42 wherein single face corrugate sheeting is placed between objects, contoured and inserted into said compartments around objects, on top of said container, on bottom of said container, or any combination thereof.
